(19) United States
(12) Patent Application Publication
(10) Pub. No.: US 2006/0164354 A1
(43) Pub. Date: Jul. 27, 2006

(54) Display device and apparatus for driving the same

(76) Inventors: Eung-Sang Lee, Yongin-si (KR); Byoung-Suk Kim, Seoul (KR)

Correspondence Address: CANTOR COLBURN, LLP, 55 GRIFFIN ROAD SOUTH, BLOOMFIELD, CT, 06002, US

(21) Appl. No.: 11/263,637

(22) Filed: Oct. 31, 2005

(30) Foreign Application Priority Data
Jan. 21, 2005 (KR) 2005-5906

(51) Int. Cl. G09G 3/36

(52) U.S. Cl. 345/89

(57) ABSTRACT

A display device includes a display panel and a voltage generating part. The display panel includes a switching element, a main pixel section, a coupling capacitor and a sub pixel section. The main pixel section is electrically connected to the switching element. The coupling capacitor has a first end electrically connected to the switching element. The sub pixel section is electrically connected to a second end of the coupling capacitor. The voltage generating part controls data voltages corresponding to a gray-scale in a range from a low gray-scale to a high gray-scale that corresponds to a saturation voltage of the sub pixel section for displaying an image. The data voltages are applied to the display panel. Therefore, the viewing angle and the luminance are improved.

This application claims priority to Korean Patent Application No. 2005-05906 filed on Jan. 21, 2005, and all the benefits occurring therefrom under 36 U.S.C. 119, the contents of which are herein incorporated by reference in its entirety.

### BACKGROUND OF THE INVENTION

1. Field of the Invention

The present invention relates to a display device and an apparatus for driving the display device. More particularly, the present invention relates to a display device for improving a viewing angle and an apparatus for driving the display device.

2. Description of the Related Art

A liquid crystal display (LCD) device, in general, includes two substrates and a liquid crystal layer inserted between the substrates. In the LCD device, in general, liquid crystal molecules of the liquid crystal layer varies in their arrangement in response to an electric field applied to the liquid crystal layer, and thus a light transmittance of the liquid crystal layer is changed when displaying images. The substrates include an array substrate (or a Thin-Film Transistor (TFT) substrate) and a color filter substrate. The array substrate includes a plurality of switching-pixel TFTs, and the color filter substrate includes a common electrode.

The LCD device displays images by transmitting light that passes through the liquid crystal of which molecules are arranged in a predetermined direction, so that the LCD devices generally have a narrower viewing angle than other display devices, such as an organic light emitting display (OLED) device, a cathode ray tube (CRT) device, a plasma display panel (PDP) device. In order to increase the viewing angle, a vertically aligned (VA) type LCD device has been developed.

The VA type LCD device includes two substrates having vertically aligned alignment layers, and a liquid crystal layer having a negative type dielectric constant anisotropy between the substrates. The liquid crystal molecules of the liquid crystal layer has homeotropic alignment characteristics.

In operation, when a voltage is not applied to the array substrate and the color filter substrate, the liquid crystal is aligned substantially in a vertical direction with respect to a surface of the array substrate, thereby displaying black. When a predetermined level of a voltage is applied to the array substrate and the counter substrate, the liquid crystal is aligned substantially in a horizontal direction with respect to the surface of the array substrate, thereby displaying white. When a level of the voltage is smaller than the predetermined level of the voltage that is required for displaying white, the liquid crystal molecules are aligned in an oblique direction with respect to the surface of the array substrate, thereby displaying a gray of various gray-scales.

A mid-size LCD device or a small-size screen LCD device displays images with a narrow viewing angle and gray-scale inversion. In order to increase the viewing angle and to decrease the gray-scale inversion, the LCD device has a Patterned Vertical Alignment (PVA) mode. The PVA type LCD device includes a color filter substrate having a patterned common electrode layer, and an array substrate having a patterned pixel electrode layer, thereby forming a plurality of domains.

A super PVA (SPVA) type LCD device that is a type of PVA type LCD device, has two separated pixel electrode areas. That is, the SPVA type LCD device includes a main pixel section and a sub pixel section that are in one pixel area and spaced apart from each other. Different pixel voltages are applied to the main and sub pixel sections.

In the SPVA type LCD device, a data voltage is directly applied to the main pixel section through a TFT, and the data voltage is indirectly applied to the sub pixel section through the TFT and a coupling capacitor so that a voltage difference is formed between the main and sub pixel sections.

Therefore, the main pixel section has liquid crystal distribution characteristics different from the sub pixel section, so that the viewing angle is improved.

However, the sub pixel section is driven by a lower voltage than the main pixel section so that the sub pixel section has lower light transmissivity than the main pixel section, thereby decreasing white luminance of the LCD device. Although the conventional SPVA type LCD devices have improved the viewing angle, the white luminance is decreased so that the image display quality of SPVA type LCD devices is decreased.

### SUMMARY OF THE INVENTION

The invention provides a display device for improving a viewing angle and a luminance.

The invention also provides a driving apparatus for driving the above-mentioned display device.

In exemplary embodiments of the present invention, a display device includes a display panel and a voltage generating part. The display panel includes a switching element, a main pixel section, a coupling capacitor and a sub pixel section. The main pixel section is electrically connected to the switching element. The coupling capacitor has a first end electrically connected to the switching element. The sub pixel section is electrically connected to a second end of the coupling capacitor. The voltage generating part controls data voltages associated with a gray-scale in a range from a low gray-scale to a high gray-scale that corresponds to a saturation voltage of the sub pixel section. The data voltages are applied to the display panel.

In another exemplary embodiment of the present invention, a display device includes a display panel, a gate driving part, a data driving part and a voltage generating part. The display panel includes a main pixel section and a sub pixel section in a unit pixel region that is defined by adjacent data and gate lines. The gate driving part applies a gate voltage to the gate lines. The data driving part applies data voltages to the data lines. The voltage generating part controls the data voltages associated with a gray-scale in a range from a low gray-scale to a high gray-scale that corresponds to a saturation voltage of the sub pixel section.

In another exemplary embodiment of the present invention, an apparatus for driving a display device includes a gate driving part, a data driving part and a voltage generating part. The display device has a main pixel section and a sub pixel section in a unit pixel area that is defined by adjacent data and gate lines. The gate driving part applies a gate voltage to the gate lines. The data driving part applies data voltages to the data lines. The voltage generating part controls the data voltages associated with a gray-scale in a range from a low gray-scale to a high gray-scale that corresponds to a saturation voltage of the sub pixel section.

In exemplary embodiments of the invention, the white voltage corresponds to the saturation of the sub pixel section to increase the viewing angle and the luminance of the display device.

### BRIEF DESCRIPTION OF THE DRAWINGS

The above and other advantages of the present invention will become more apparent by describing in detail exemplary embodiments thereof with reference to the accompanying drawings, in which:

FIG. 1 is a block diagram illustrating an exemplary embodiment of a liquid crystal display (LCD) device according to the present invention;

FIG. 2 is a plan view illustrating an exemplary embodiment of an LCD panel of the exemplary LCD device in FIG. 1;

FIG. 3 is a block diagram illustrating an exemplary embodiment of a gamma voltage generating part in FIG. 1;

FIG. 4 is a block diagram illustrating an exemplary embodiment of a gamma voltage generating part according to the present invention;

FIG. 5 is a graph illustrating luminance characteristics with respect to data voltages applied to an exemplary embodiment of a main pixel section and a sub pixel section according to the present invention;

FIG. 6 is a graph illustrating luminance characteristics with respect to data voltages applied to another exemplary embodiment of a main pixel section and a sub pixel section according to the present invention;

FIG. 7 is a graph illustrating luminance characteristics with respect to gray-scales corresponding to an exemplary embodiment of a main pixel section and a sub pixel section according to the present invention; and

FIG. 8 is a graph illustrating luminance characteristics with respect to gray-scales corresponding to another exemplary embodiment of the main pixel section and the sub pixel section according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first thin film could be termed a second thin film, and, similarly, a second thin film could be termed a first thin film without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

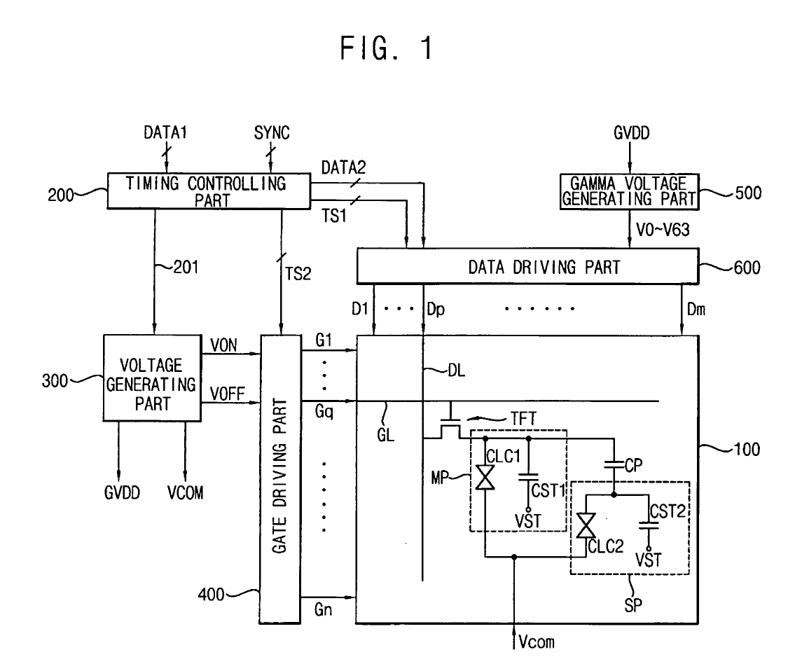

FIG. 1 is a block diagram illustrating an exemplary embodiment of a liquid crystal display (LCD) device according to the present invention.

Referring to FIG. 1, the LCD device includes an LCD panel 100, a timing controlling part 200, a voltage generating part 300, a gate driving part 400, a gamma voltage generating part 500 and a data driving part 600.

The LCD panel 100 includes a gate line GL, a data line DL, a switching element TFT, a main pixel section MP, a coupling capacitor CP and a sub pixel section SP. In this embodiment, the LCD panel 100 may include a plurality of gate lines GL, a plurality of data lines DL, a plurality of switching elements TFT, a plurality of main pixel sections MP, a plurality of coupling capacitors CP and a plurality of sub pixel sections SP.

Particularly, the gate lines GL transmit gate signals to the switching elements TFT to turn on the switching elements TFT, respectively, and the data lines DL transmit data signals to the switching elements TFT, respectively. As shown in FIG. 1, the gate lines GL and the data lines DL are configured substantially perpendicular to each other, while not necessary to.

In the exemplary embodiment of FIG. 1, the main pixel section MP includes a main liquid crystal capacitor CLC1 and a main storage capacitor CST1. One end of the main liquid crystal capacitor CLC1 is electrically connected to the switching element TFT, and another end of the main liquid crystal capacitor CLC1 is electrically connected to a common voltage Vcom. One end of the main storage capacitor CST1 is electrically connected to the switching element TFT, and another end of the main storage capacitor CST1 is electrically connected to a storage voltage VST.

The coupling capacitor CP has a first end electrically connected to the switching element TFT and a second end electrically connected to the sub pixel section SP.

The sub pixel section SP includes a sub liquid crystal capacitor CLC2 and a sub storage capacitor CST2. One end of the sub liquid crystal capacitor CLC2 is electrically connected to the coupling capacitor CP, and the other end of the sub liquid crystal capacitor CLC2 is electrically connected to the common voltage Vcom. One end of the sub storage capacitor CST2 is electrically connected to the coupling capacitor CP, and another end of the sub storage capacitor CST2 is electrically connected to the storage voltage VST.

The timing controlling part 200 receives a raw image signal DATA1 and a first timing signal SYNC from a host (not shown). The host includes, but it not limited to, an external graphic controller. The timing controlling part 200 provides the voltage generating part 300 with a second timing signal 201 that defines a frequency and a magnitude of the common voltage Vcom. The timing controlling part 200 also provides the data driving part 600 with an image data signal DATA2 and a third timing signal TS1. Additionally, the timing controlling part 200 provides the gate driving part 400 with a fourth timing signal TS2.

In alternative embodiments, the first timing signal SYNC may include, but is not limited to, a horizontal synchronization signal (Hsync), a vertical synchronization signal (Vsync), a data-enable signal (DE), and a main clock (MCLK). In other exemplary embodiments, the third timing signal TS1 may include, but is not limited to, a load signal (LOAD) and a horizontal start signal (STH). In still other exemplary embodiments, the fourth timing signal TS2 may include, but is not limited to, gate clock (Gate CLK) and a vertical start signal (STV).

In the exemplary embodiment of FIG. 1, the voltage generating part 300 receives the second timing signal 201 from the timing controlling part 200, and provides the gate driving part 400 with a gate on voltage VON and a gate off voltage VOFF.

The voltage generating part 300 also outputs the common voltage Vcom to the LCD panel 100. The common voltage Vcom is synchronized with the gate signals G1, G2, . . . , Gq, . . . , Gn−1 and Gn at a constant interval.

The voltage generating part 300 provides the gamma voltage generating part 500 with a gamma source voltage GVDD so that data voltages are applied to the LCD panel 100 for displaying images. The data voltages correspond to gray-scales of a low gray-scale (for example, black) to a high gray-scale (for example, white). Particularly, the voltage generating part 300 provides the gamma voltage generating part 500 with the gamma source voltage GVDD such that the data voltage corresponding to the high gray-scale is within a certain voltage range that corresponds to a saturation of the sub pixel section SP.

The gate driving part 400 outputs the gate signals G1, G2, . . . , Gq, . . . , Gn−1 and Gn, based on the gate clock (Gate CLK), the vertical start signal (STV) and the gate on/off voltage VON and VOFF that may be provided by the voltage generating part 300. The gate signals G1, G2, . . . , Gq, . . . , Gn−1 and Gn selectively activate the gate lines.

The gamma voltage generating part 500 generates a plurality of gray-scale voltages V0, V1, . . . and V63 based on the gamma source voltage GVDD that is provided from the voltage generating part 300, and outputs the gray-scale voltages to the data driving part 600. The gamma source voltage GVDD is a data voltage corresponding to the high gray-scale that corresponds to a saturation voltage of the sub pixel section SP. When a voltage greater than the saturation voltage of the sub pixel section SP is applied to the sub pixel section SP, a luminance corresponding to the sub pixel section SP maintains a predetermined value.

The data driving part 600 generates a plurality of data voltages D1, D2, Dp, . . . , Dm−1 and Dm based on the image data signal DATA2, the third timing signal TS1 that may include the load signal LOAD and the horizontal start signal STH, and the gray-scale voltages V0, V1, . . . and V63. The data voltages D1, D2, . . . , Dp, Dm−1 and Dm are applied to the data lines DL.

In exemplary embodiments, when the common voltage Vcom is applied to a pixel, the data voltages D1, D2, . . . , Dp, . . . , Dm−1 and Dm may have an inverted polarity with respect to the common voltage Vcom. For example, when the common voltage Vcom has a low level, the data voltages D1, D2, . . . , Dp, . . . , Dm−1 and Dm have a high level with respect to the common voltage Vcom. Also, when the common voltage Vcom has a high level, the data voltages D1, D2, . . . , Dp, . . . , Dm−1 and Dm have a low level with respect to the common voltage Vcom.

According to the exemplary embodiment of FIG. 1, the gamma source voltage GVDD that generates the gamma voltages is adjusted so that the data voltage of a white image is substantially equal to the saturation voltage of the sub pixel section. Advantageously, the viewing angle and the luminance are increased. In alternative embodiments, particularly in an SPVA-type LCD device, the viewing angle may be improved although the luminance is not decreased.

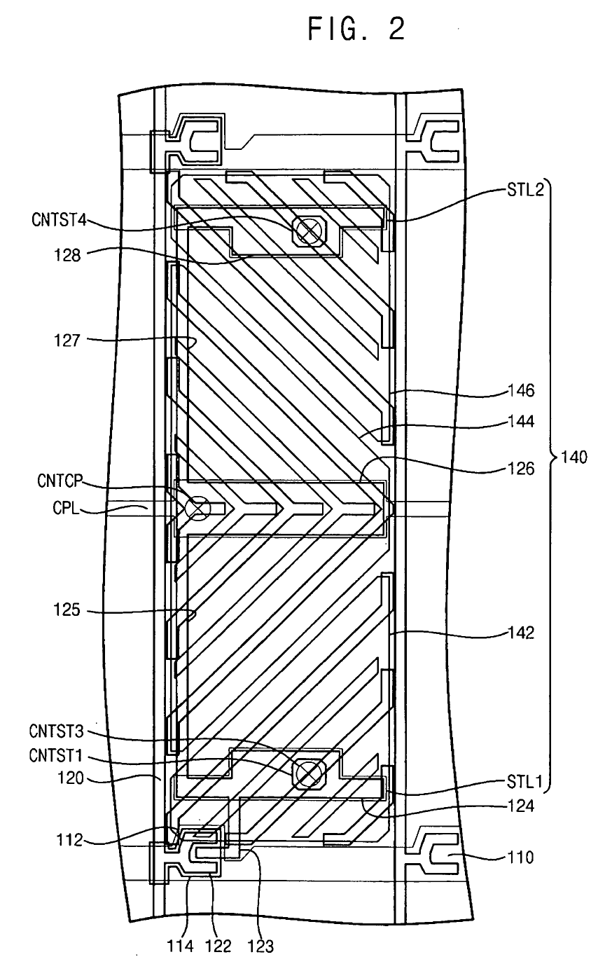

FIG. 2 is a plan view illustrating an exemplary embodiment of an LCD panel of the exemplary LCD device in FIG. 1. Particularly, the LCD panel may have a transmissive type array substrate as shown in FIG. 2.

Referring to FIG. 2, the LCD panel includes an array substrate, a liquid crystal layer, and a color filter substrate. The color filter substrate is combined with the array substrate so that the liquid crystal layer is interposed between the array substrate and the color filter substrate.

The array substrate includes a gate line 110 extended in a horizontal direction on an insulating substrate (not shown), a gate electrode 112 stemming from the gate line 110, first and second lower storage patterns STL1 and STL2 that are substantially in parallel with the gate line 110, and a first coupling pattern CPL horizontally dividing the unit pixel area into two regions. The first and second lower storage patterns STL1 and STL2 are in a unit cell area and spaced apart from the gate line 110.

The array substrate may include a gate insulating layer (not shown) that covers the gate line 110 and the gate electrode 112, and an active layer 114 that is on the gate insulating layer (not shown) corresponding to the gate electrode 112. The gate insulating layer may include an insulating material. Examples of the insulating material that may be used for the gate insulating layer include, but are not limited to, silicon nitride (SiNx) and silicon oxide (SiOx). The active layer 114 includes a semiconductor layer which may include, but is not limited to, an amorphous silicon (a-Si) layer. The active layer 114 may also include a semiconductor impurity layer which may include, but is not limited to, an N+ a-Si layer formed on the semiconductor layer.

The array substrate includes a source line 120 extended in a longitudinal direction of the unit cell, a source electrode 122 stemming from the source line 120, and a drain electrode 123 spaced apart from the source electrode 122 by a gap. The gate electrode 112, the active layer 114, the semiconductor impurity layer (not shown), the source electrode 122 and the drain electrode 123 constitute a Thin-Film Transistor (TFT).

The array substrate may also include a first upper storage pattern 124 electrically connected to the drain electrode 123, a first extension pattern 125 electrically connected to the drain electrode 123 and formed on a left portion of the unit pixel area, a second coupling pattern 126 electrically connected to the first extension pattern 125, a second extension pattern 127 electrically connected to the first extension pattern 125 and formed on a left portion of the unit pixel area, and a second upper storage pattern 128 electrically connected to the second extension pattern 127.

In exemplary embodiments, each of the gate line 110 and the source line 120 may have a single layered structure or a multi-layered structure. For example, when each of the gate and source lines 110 and 120 has the single layered structure, each of the gate and source lines may include, but is not limited to, Aluminum (Al), Aluminum-Neodymium (Al—Nd) alloy, and the like, as well as combinations including at least one of the foregoing.

In alternative embodiments, when each of the gate and source lines 110 and 120 has a double layered structure, each of the gate and source lines includes a lower layer and an upper layer disposed on the lower layer. The lower layer may include a material having good physical and chemical characteristics. Examples of the material having the good physical and chemical characteristics include, but are not limited to, chrome (Cr), molybdenum (Mo), molybdenum alloy, and the like. The upper layer may include a material having a low resistivity. Examples of the material having the low resistivity may include, but are not limited to, Aluminum (Al), Aluminum alloy, and the like.

In this embodiment, the array substrate includes a passivation layer (not shown) and an organic insulating layer (not shown) on the passivation layer. The passivation layer and the organic insulating layer cover the TFT, and have a first contact hole CNTST1 through which the drain electrode 123 is partially exposed, a third contact hole CNTST3 through which the first lower storage pattern STL1 is partially exposed, a central contact hole CNTCP through which the second coupling pattern 126 is partially exposed, and a fourth contact hole CNTST4 through which the second lower storage pattern STL2 is partially exposed. The passivation layer and the organic insulating layer protect the active layer 114 between the source electrode 122 and the drain electrode 123. The TFT is electrically insulated from a pixel electrode 140 by the passivation layer and the organic insulating layer. In exemplary embodiments, thickness of the liquid crystal layer varies in response to a vertical dimension of the organic insulating layer. In alternative embodiments, the passivation layer may be omitted.

As shown in FIG. 2, the array substrate includes the pixel electrode 140 having opening patterns. The pixel electrode 140 is electrically connected to the drain electrode 123 of the TFT through the contact holes CNTST1, CNTST3, CNTCP and CNTST4.

Particularly, the pixel electrode 140 includes a main electrode 144 electrically connected to the second coupling pattern 126 through the central contact hole CNTCP, a first sub electrode 142 electrically connected to the first lower storage pattern STL1 through the third contact hole CNTST3 and a second sub electrode 146 electrically connected to the second lower storage pattern STL2 through the fourth contact hole CNTST4. The second sub electrode 146 is electrically insulated from the first sub electrode 142.

In exemplary embodiments, the main electrode 144 may have a pair of Y-shaped opening patterns that are substantially mirror-symmetric with respect to a horizontal central line of the unit pixel area. Branches of the Y-shaped opening patterns may form an angle of about 90 degrees. In alternative embodiments, the first sub electrode 142 may have a pair of opening patterns substantially in parallel with one of the branches of each of the Y-shaped opening patterns. In other alternative embodiments, the second sub electrode 146 may have a pair of opening patterns formed substantially in parallel with another branch of each of the Y-shaped opening patterns substantially mirror-symmetric to the opening patterns of the first sub electrode 142 with respect to the horizontal central line of the unit pixel area. The opening patterns of the main electrode 144 and the first and second sub electrodes 142 and 146 may form a distorted electric field, thereby forming a multi-domain that includes domains between the array substrate and the color filter substrate.

In exemplary embodiments, the main electrode 144 and the first and second sub electrodes 142 and 146 may include a transparent conductive material. Examples of the transparent conductive materials that can be used for the main electrode 144 and the first and second sub electrodes 142 and 146 include, but are not limited to, Indium Tin Oxide (ITO), Indium Zinc Oxide (IZO), or Zinc Oxide (ZO), and the like, as well as any combinations includes at least one of the foregoing.

The color filter substrate may include a color filter layer formed on the transparent substrate corresponding to the unit pixel area, and a common electrode part that is on the color filter layer and covers the opening patterns of the pixel electrode formed on the array substrate. The common electrode part may include opening patterns. The color filter substrate may be combined with the array substrate, and the liquid crystal layer is disposed between the color filter substrate and the array substrate. The liquid crystal molecules in the liquid crystal layer are aligned in the Vertical Alignment (VA) mode.

Different domains may be formed by the main electrode 144, the first and second sub electrodes 142 and 146, respectively. Advantageously, a rubbing process for rubbing a surface of the alignment layer in which the liquid crystal molecules are aligned, may be performed or omitted in exemplary embodiments. In alternative embodiments, the alignment layer may also be omitted.

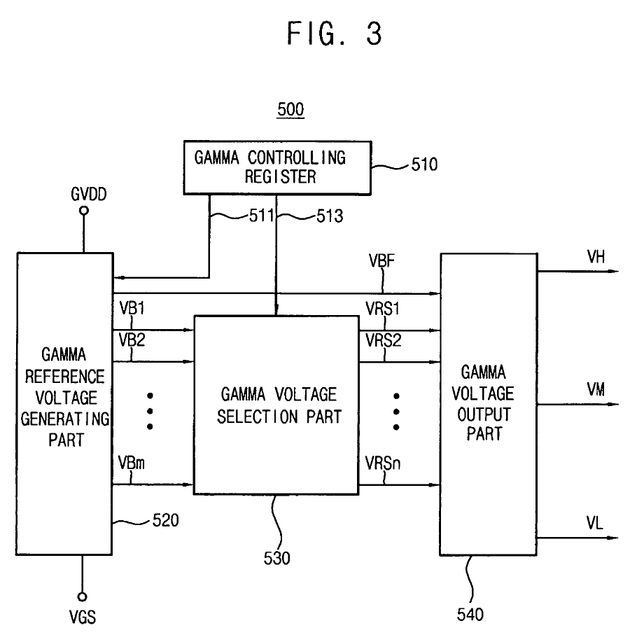

FIG. 3 is a block diagram illustrating an exemplary embodiment of a gamma voltage generating part in FIG. 1.

Referring to FIG. 3, the gamma voltage generating part 500 includes a gamma controlling register 510, a gamma reference voltage generating part 520, a gamma voltage selection part 530, and a gamma voltage output part 540. The gamma voltage generating part 500 outputs gray-scale voltages to the data driving part 600. The gray-scale voltage of a white image is the saturation voltage of the sub pixel section.

The gamma controlling register 510 provides the gamma reference voltage generating part 520 with a first register value 511 for selecting the gamma voltage, and provides the gamma voltage selection part 530 with a second register value 513 for selecting the gamma voltage.

In this embodiment, the gamma reference voltage generating part 520 outputs a reference raw gamma voltage VBF to the gamma voltage output part 540 in response to the first register value 511, and outputs ‘m’ variable raw gamma voltages VB1, VB2, . . . and VBm to the gamma voltage selection part 530. One end of the gamma reference voltage generating part 520 is electrically connected to the gamma source voltage GVDD, and another end of the gamma reference voltage generating part 520 is electrically connected to the ground source voltage VGS.

As shown in FIG. 3, the gamma voltage selection part 530 selects ‘n’ gamma voltages VRS1, VRS2, . . . and VRSn among the ‘m’ variable raw gamma voltages VB1, VB2, . . . and VBm based on the second register value 513, and then outputs the selected ‘n’ gamma voltages VRS1, VRS2, . . . and VRSn to the gamma voltage output part 540.

The gamma voltage output part 540 outputs a plurality of gamma voltages VH, VM and VL that have different voltage levels from one another. The difference in the gamma voltages VH, VM and VL is based on the reference raw gamma voltage VBF from gamma reference voltage generating part 520, and the ‘n’ gamma voltages VRS1, VRS2, . . . and VRSn from the gamma voltage selection part 530.

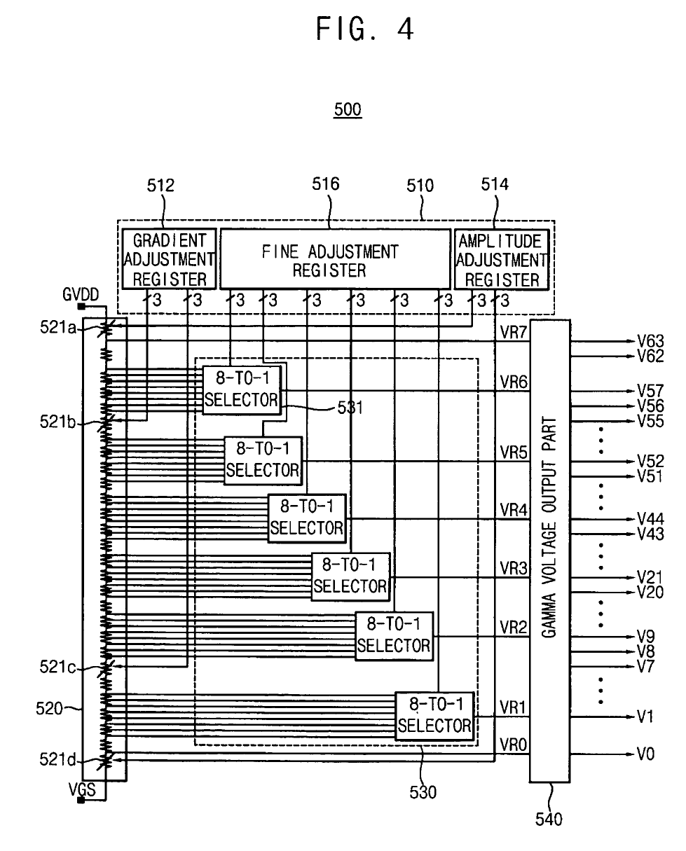

FIG. 4 is a block diagram illustrating an exemplary embodiment of a gamma voltage generating part according to the present invention.

Referring to FIG. 4, the gamma voltage generating part 500 includes the gamma controlling register 510, the gamma reference voltage generating part 520, the gamma voltage selection part 530, and the gamma voltage output part 540.

The gamma controlling register 510 includes a gradient adjustment register 512, an amplitude adjustment register 514, and a fine adjustment register 516. The gamma controlling register 510 outputs register values for selecting the gamma voltages to the gamma reference voltage generating part 520 and the gamma voltage selection part 530.

Gamma curves are defined by the gamma voltages that are outputted from the gamma voltage output part 540 to the gamma controlling register 510, and controlled by the gradient adjustment register 512, the amplitude adjustment register 514 and the fine adjustment register 516.

In the exemplary embodiment of FIG. 4, the gradient adjustment register 512 provides the gamma reference voltage generating part 520 with register values for controlling a gradient of levels of the gray-scale voltages with respect to the number of the gray-scales. Accordingly, the gamma voltages from the gamma voltage output part 540 define the gamma curves corresponding to the gray-scale voltage variation.

The amplitude adjustment register 514 provides the gamma reference voltage generating part 520 with register values for controlling amplitudes of the gray-scale voltages with respect to the number of the gray-scales. Accordingly, the gamma voltages from the gamma voltage output part 540 define the gamma curves corresponding to the gray-scale voltage variation.

The fine adjustment register 516 provides the gamma voltage selecting part 530 with register values for minutely controlling the gray-scale voltages with respect to the number of the gray-scales. Accordingly, the gamma voltages from the gamma voltage output part 540 define the gamma curves corresponding to the gray-scale voltage variation.

The gamma reference voltage generating part 520 may include a resistor string having a plurality of resistors connected between the gamma source voltage GVDD and the ground source voltage VGS. The resistors of the resistor string as shown in the exemplary embodiment of FIG. 4, are connected in series.

The resistor string outputs the gamma reference voltages that have various levels to the gamma voltage selection part 530 and the gamma voltage output part 540 based on the gamma source voltage GVDD and the ground source voltage VGS.

The resistor string includes a plurality of fixed resistors and a plurality of variable resistors to divide a voltage applied in the gamma reference voltage generating part 520. In the exemplary embodiment of FIG. 4, the variable resistors includes first, second, third and fourth variable resistors 521a, 521b, 521c and 521d. In alternative embodiments, the number of the variable resistors may be less than three or more than five.

In exemplary embodiments, the gamma voltage selection part 530 may include six ‘8-to-1’ selectors 531. Each of the ‘8-to-1’ selectors 531 selects one voltage among eight gamma reference voltages that have eight levels, respectively, in response to 3-bit register data that are from the fine adjustment register 516. The eight levels of the gamma reference voltages may be different from one another. The six selected gamma reference voltages VR1, VR2, . . . and VR6 are applied to the gamma voltage output part 540.

The gamma voltage output part 540 outputs a plurality of gamma voltages V0, V1, . . . , V62 and V63 based on the raw gamma voltages VR0 and VR7 from the gamma reference voltage generating part 520 and the six gamma reference voltages VR1, . . . and VR6 from the gamma voltage selection part 530.

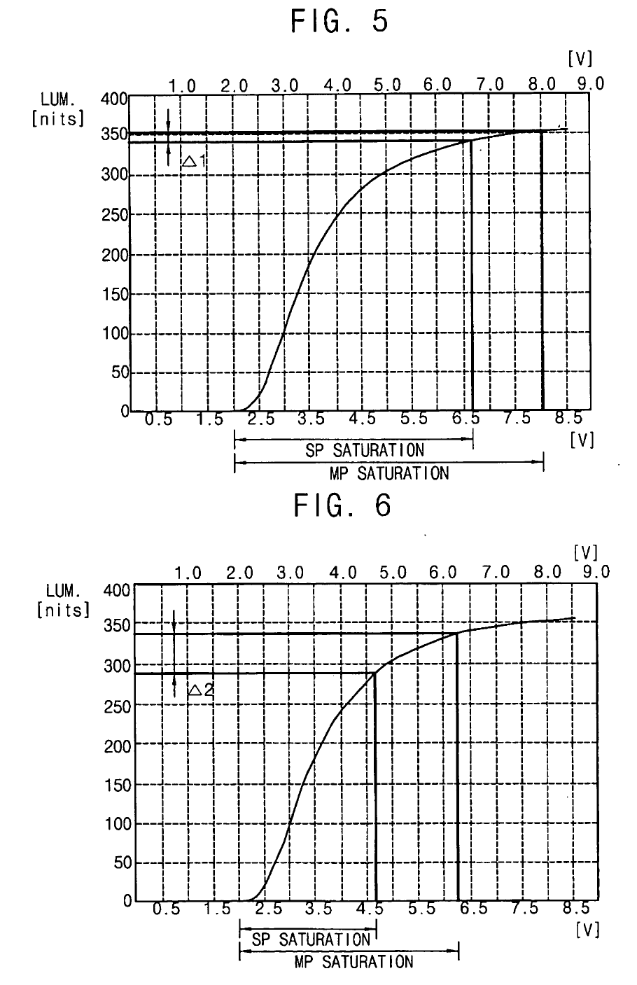

Graphs for illustrating measured data according to exemplary embodiments of the present invention are provided in FIGS. 5 to 8.

<Relationship between Luminance and Data Voltage>

FIG. 5 is a graph illustrating luminance characteristics with respect to data voltages applied to an exemplary embodiment of a main pixel section MP and a sub pixel section SP according to the present invention. FIG. 6 is a graph illustrating luminance characteristics with respect to data voltages applied to another exemplary embodiment of a main pixel section (MP) and a sub pixel section (SP) according to the present invention.

I FIGS. 5 and 6, a level of data voltage applied to the unit pixel is gradually increased. When the level of the data voltage is more than 2V, a luminance begins to be observed. When the data voltage becomess 3V, 4V, 5V, 6V and 7V, the luminance becomes 100 nits, 250 nits, 300 nits, 330 nits and 345 nits, respectively. When the data voltage is 8V, the unit pixel was saturated, and the luminance is 350 nits.

Referring to the graph of FIG. 5, a data voltage saturating a sub pixel section SP having lower saturation voltage than the main pixel section MP is a high gray-scale that is a white voltage. The white voltage that is the saturation voltage of the sub pixel section SP is shown as 6.6V in this example. When the white voltage of the sub pixel section SP is 6.6V, a voltage applied to the main pixel section MP is 8V.

A difference of Δ1 of the luminance of the white voltage, or the saturation voltage, between the main pixel section MP and the sub pixel section SP, is approximately 25 nits as shown in FIG. 5.

Referring to the graph of FIG. 6, a data voltage saturating a main pixel section MP that has greater saturation voltage than the sub pixel section SP is a high gray-scale that is a white voltage. The white voltage that is the saturation voltage of the main pixel section MP is shown as 6.3V in this example. When the white voltage of the main pixel section MP is 6.3V, a voltage applied to the sub pixel section SP is 4.6V.

A difference of Δ2 of the luminance of the white voltage, or the saturation voltage, between the main pixel section MP and the sub pixel section SP, is approximately 50 nits as shown in FIG. 6.

Graphs for illustrating a relationship between a luminance and a gray-scale that correspond to the exemplary embodiments of the graphs in FIGS. 5 and 6 are provided as follows.

<Comparison of Luminance Against Gray-Scale>

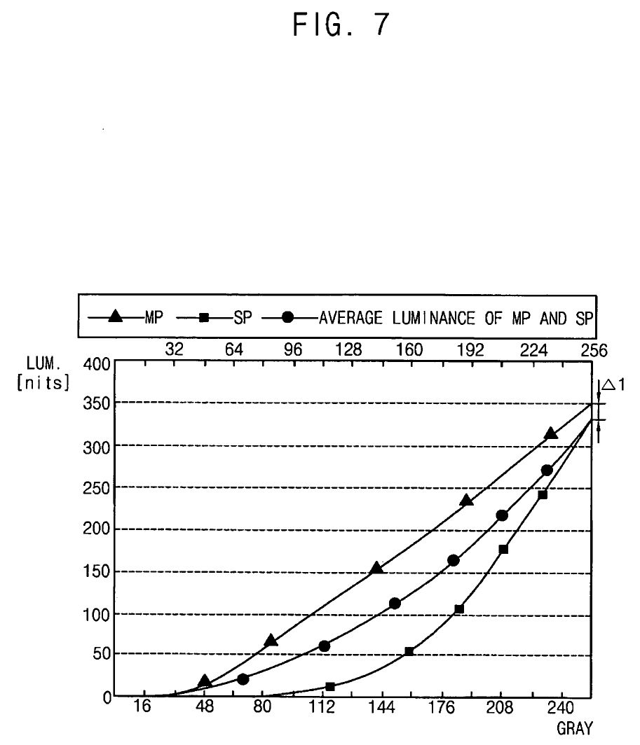

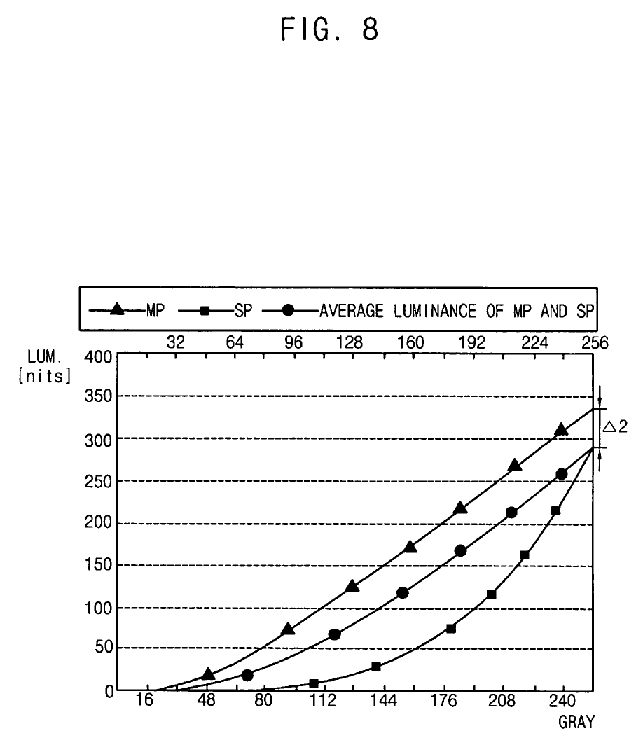

FIG. 7 is a graph illustrating luminance characteristics with respect to gray-scales corresponding to an exemplary embodiment of a main pixel section MP and a sub pixel SP section according to the present invention. FIG. 8 is a graph illustrating luminance characteristics with respect to gray-scales corresponding to another exemplary embodiment of a main pixel section MP and a sub pixel section SP according to the present invention.

In the graph of FIG. 7, a luminance of a full gray-scale, for example, a 256-gray-scale, for the main pixel section MP is shown as 350 nits, and a luminance of a full gray-scale for the sub pixel section SP is shown as 325 nits. The full gray-scale corresponds to a white voltage. A discrepancy Δ1 of the luminance of the full gray-scale between the main pixel section MP and the sub pixel section SP is shown as 25 nits.

As shown in the graph of FIG. 7, when the main and sub pixel sections MP and SP are simultaneously driven, an average luminance corresponding to the full gray-scale for the main and sub pixel sections MP and SP is 325 nits.

In the graph of FIG. 8, a luminance of a full gray-scale, for example, a 256-gray-scale, for the main pixel section MP is shown as 345 nits, and a luminance of a full gray-scale for the sub pixel section SP is shown as 294 nits. A discrepancy Δ2 of the luminance of the full gray-scale between the main pixel section MP and the sub pixel section SP is shown as 51 nits.

As shown in the graph of FIG. 8, when the main and sub pixel sections MP and SP are simultaneously driven, an average luminance corresponding to the full gray-scale for the main and sub pixel sections MP and SP is 294 nits.

In exemplary embodiments, when the white voltage is the saturation voltage of the main pixel section MP, the luminance of the sub pixel section SP may be significantly smaller than the luminance of the main pixel section MP.

However, in alternative embodiments, when the white voltage is the saturation voltage of the sub pixel section SP, the luminance of the sub pixel section SP may be substantially equal to that of the main pixel section MP. Advantageously, the luminance of the sub pixel section SP is increased. For example, when the saturation voltage is applied to the main pixel section MP and the sub pixel section SP, the difference between the luminance of the main pixel section MP and the luminance of the sub pixel section SP is significantly decreased.

According to the exemplary embodiments of the present invention discussed hereinabove, the sub pixel section SP is operated by a lower voltage than the main pixel section MP so that the luminance of the sub pixel section SP may be smaller than the luminance of the main pixel section MP. The white voltage may be the saturation voltage of the sub pixel section SP to decrease the difference between the luminance of the main pixel section MP and the luminance of the sub pixel section SP. In addition, the luminance of the main pixel section MP and the sub pixel section SP are advantageously increased.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display device comprising:
a display panel including:
a switching element;
a main pixel section electrically connected to the switching element;
a coupling capacitor having a first end electrically connected to the switching element; and
a sub pixel section electrically connected to a second end of the coupling capacitor; and
a voltage generating part that controls data voltages associated with a gray-scale in a range from a low gray-scale to a high gray-scale that corresponds to a saturation voltage of the sub pixel section, the data voltages being applied to the display panel.

2. The display device of claim 1, wherein the gray scale is in a range of a gray scale corresponding to black and a gray scale corresponding to white.

3. The display device of claim 1, wherein the main pixel section comprises a liquid crystal capacitor having a first end electrically connected to a drain of the switching element and a second end electrically connected to a common voltage terminal.

4. The display device of claim 1, wherein the sub pixel section comprises a liquid crystal capacitor including a first end electrically connected to the coupling capacitor and a second end electrically connected to a common voltage terminal.

5. The display device of claim 1, wherein the display panel comprises two substrates and a liquid crystal layer disposed between the substrates, the liquid crystal layer having a normally black mode.

6. The display device of claim 1, further comprising a gamma voltage generating part outputting gray-scale voltages based on a gamma source voltage outputted from the voltage generating part, the data voltage corresponding to the high gray-scale being the saturation voltage of the sub pixel section.

7. The display device of claim 6, further comprising a data driving part applying the data voltages to the display panel based on the gray-scale voltages.

8. The display device of claim 6, wherein the gamma voltage generating part further comprising a controlling register providing first register data to a gamma reference voltage generating part and a second register data to a gamma voltage selection part, the gamma reference voltage generating part electrically connecting to the gamma source voltage and a ground source voltage.

9. The display device of claim 6, wherein the gamma voltage generating part further comprising a gamma controlling register receiving gamma voltages from a gamma voltage output part, the gamma controlling register comprising:
a gradient adjustment register providing a gamma reference voltage generating part with register values for controlling gradient levels of the gray-scale voltages;
an amplitude adjustment register providing the gamma reference voltage generating part with register values for controlling amplitudes of the gray-scale voltages; and
a fine adjustment register providing a gamma voltage selection part with register values for controlling the gray-scale voltages.

10. The display device of claim 9, wherein the gamma reference voltage generating part comprising a resistor string, the resistor string including a plurality of resistors connected between the gamma source voltage and the ground source voltage.

11. The display device of claim 9, wherein the gamma voltage selection part including selectors for selecting gamma reference voltages applied to the gamma voltage output part.

12. The display device of claim 11, wherein each of the selectors receives a selected number of gamma reference voltages and selects one of the gamma reference voltages in response to register data provided from the fine adjustment region.

13. A display device comprises:
a display panel including a main pixel section and a sub pixel section in a unit pixel region, the unit pixel region defined by adjacent data and gate lines;
a gate driving part applying a gate voltage to the gate lines;
a data driving part applying data voltages to the data lines; and
a voltage generating part that controls the data voltages associated with a gray-scale in a range from a low gray-scale to a high gray-scale that corresponds to a saturation voltage of the sub pixel section.

14. The display device of claim 13, further comprising a gamma voltage generating part outputting gray-scale voltages based on a gamma source voltage outputted from the voltage generating part, the data voltage corresponding to the high gray-scale being the saturation voltage of the sub pixel section.

15. The display device of claim 14, wherein the data driving part applies the data voltages to the display panel based on the gray-scale voltages.

16. The display device of claim 13, wherein the display panel comprises:
a switching element electrically connected to one of the gate lines and one of the data lines; and
a coupling capacitor electrically connected to the switching element,
wherein the main pixel section is electrically connected to the switching element, and the sub pixel section is electrically connected to the switching element through the coupling capacitor.

17. An apparatus for driving a display device, the display device having a main pixel section and a sub pixel section in a unit pixel area, the unit pixel area defined by adjacent data and gate lines, the apparatus comprising:
a gate driving part applying a gate voltage to the gate lines;
a data driving part applying data voltages to the data lines; and
a voltage generating part that controls the data voltages associated with a gray-scale in a range from a low gray-scale to a high gray-scale that corresponds to a saturation voltage of the sub pixel section.

18. The apparatus of claim 17, further comprising a gamma voltage generating part outputting gray-scale voltages based on a gamma source voltage outputted from the voltage generating part, the data voltage corresponding to the high gray-scale being the saturation voltage of the sub pixel section.

19. The driving circuit of claim 18, wherein a data driving part provides the data voltages to the display panel based on the gray-scale voltages.
